(19) United States
(12) Patent Application Publication
(10) Pub. No.: US 2014/0279583 A1
(43) Pub. Date: Sep. 18, 2014

(54) Systems and Methods for Classifying Entities

(71) Applicant: Lex Machina, Inc., Menlo Park, CA (US)

(72) Inventors: Mihai Surdeanu, Tucson, AZ (US); Sara Ellyn Jeruss, San Francisco, CA (US); Joshua H. Walker, Los Altos, CA (US)

(73) Assignee: Lex Machina, Inc., Menlo Park, CA (US)

(21) Appl. No.: 14/207,223

(22) Filed: Mar. 12, 2014

Related U.S. Application Data
(60) Provisional application No. 61/785,341, filed on Mar. 14, 2013.

(51) Int. Cl. G06Q 50/18; G06Q 10/10

(52) U.S. Cl. CPC G06Q 50/184; G06Q 10/10
USPC 705/310

(57) ABSTRACT

Presented herein are systems and method for generating and/or using a classifier that can identify or classify entities, such as (by way of illustration and not limitation) whether an entity in a contested proceeding is a patent monetizing entity (PME). In embodiments, using features extracted from various sources such as, by way of example and not limitation, the entities' litigation behavior, the patents they asserted, and their presence on the web, a classifier can correctly separates PMEs from operating companies with a reasonable degree of accuracy. In embodiments, one or more classifier may be trained to classify or label entities into one of a plurality of classes. Such classifiers can be useful tools for policy makers and others, allowing them to gain a clearer picture of contested proceedings filed to date and assessing newly filed cases in real time.

### CROSS-REFERENCE TO RELATED APPLICATION

This application claims the priority benefit under 35 USC §119(e) to commonly assigned and co-pending U.S. Patent Application No. 61/785,341 (Attorney Docket No. 20103-1773P), filed on Mar. 14, 2013, entitled “IDENTIFYING PATENT MONETIZING ENTITIES,” and listing as inventors Mihai Surdeanu and Sara E. Jeruss. The aforementioned patent document and the documents referenced therein are incorporated by reference herein in their entirety.

This application is related to commonly assigned and co-pending U.S. patent application Ser. No. 13/745,117 (Attorney Docket No. 20103-1767), filed on Jan. 18, 2013, entitled “SYSTEMS AND METHODS FOR USING NON-TEXTUAL INFORMATION IN ANALYZING PATENT MATTERS,” and listing as inventors Mihai Surdeanu, Ingrid K. Foster, Carla L. Rydholm, Ramesh M. Nallapati, Joshua H. Walker, George D. Gregory, Gavin Carothers, and Nickolas O. P. Pilon; which patent application claims the priority benefit under 35 USC §119(e) to commonly assigned U.S. Patent Application No. 61/740,905 (Attorney Docket No. 20103-1767P), filed on Dec. 12, 2012, entitled “SYSTEMS AND METHODS FOR USING NON-TEXTUAL INFORMATION IN ANALYZING PATENT MATTERS,” and listing as inventor Mihai Surdeanu. The aforementioned patent documents and the documents referenced therein are incorporated by reference herein in their entirety.

### COPYRIGHT NOTICE

A portion of this patent document may contain material which is subject to copyright protection. To the extent required by law, the copyright owner has no objection to the facsimile reproduction of the document, as it appears in the U.S. Patent and Trademark Office patent file or records, but otherwise reserves all copyright rights whatsoever.

### BACKGROUND

A. Technical Field

The present invention pertains generally to computer applications, and relates more particularly to systems and methods for creating models for classifying entities and for using models to classify entities.

B. Background of the Invention

Intellectual property, especially patent matters, has become increasingly more prominent as business assets. These patents assets have received increased media attention as they have been the subject of business transactions, such as patent auctions, and contested matters, such as patent litigations.

The United States has seen an explosion in patent litigation lawsuits in recent years. For example, according to data aggregated by Lex Machina, Inc., of Palo Alto, Calif., in 2000 there were 2281 patent lawsuits filed. By 2011, that number had climbed to 3544. And, in 2012, a record 5434 patent lawsuits were filed.

Public perception is that the rise in lawsuits is due to an increase in lawsuits filed by patent monetization entities (PMEs). Patent monetization entities are companies that hold patents, license patents, and file patent lawsuits, but do not sell products or provide services practicing the technologies described in their patents, or any related technologies. Their business model depends on extracting revenue from licensing and litigation, rather than from product sales. For example, Acacia Research Group describes itself as a “leader in patent licensing and enforcement.”

Although companies that practice their patented technology also engage in efforts to monetize their patents through litigation and licensing, public scrutiny has focused largely on PMEs. Numerous academics and commentators—including Federal Judge Richard Posner—have advocated for patent reforms aimed at curbing monetizer activity, and, in 2011, Congress passed the 2011 Patent Reform Act, H.R. 1249 (112^{th}), known as the “America Invents Act.”

While the question of what to do about monetizers is hotly debated, policy makers lack basic data on just how many lawsuits are filed by monetizers, whether there has, in fact, been an increase in the percentage of lawsuits filed by monetizers, and whether monetizer litigation behavior and outcomes differ from those of other litigating entities. Obtaining such information and determining what characteristics to investigate has been done manually. However, given the vast number of patent lawsuits that have been filed over the last few years, manual investigation is an infeasible or impossible option.

Accordingly, what are needed are systems and methods by which models may be generated and used to help automate the process of classifying patent monetizing entities.

### BRIEF DESCRIPTION OF THE DRAWINGS

Reference will be made to embodiments of the invention, examples of which may be illustrated in the accompanying figures. These figures are intended to be illustrative, not limiting. Also, although the invention is generally described in the context of these embodiments, it should be understood that it is not intended to limit the scope of the invention to these particular embodiments.

FIG. 1 depicts a method for generating a classification model according to embodiments of the present invention.

FIG. 2 lists the ten largest weights learned for the PME class according to embodiments of the present invention.

FIG. 3 lists the ten largest weights learned for the OC class according to embodiments of the present invention.

FIG. 4 depicts a block diagram of a model trainer for developing a patent monetizing classifier model according to embodiments of the present invention.

FIG. 5 depicts a block diagram of an entity model classifier that uses a trained model to classify an entity according to embodiments of the present invention.

FIG. 6 depicts a block diagram of an example of a computing system according to embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or instructions on a tangible computer-readable medium.

Also, it shall be noted that steps or operations may be performed in different orders or concurrently, as will be apparent to one of skill in the art. And, in instances, well-known process operations have not been described in detail to avoid unnecessarily obscuring the present invention.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules. Components or modules may be implemented in software, hardware, or a combination thereof.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of such phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. A set or group shall be understood to include any number of items.

Embodiments of the present invention presented herein will be described using patent matter examples. These examples are provided by way of illustration and not by way of limitation. One skilled in the art shall also recognize the general applicability of the present invention to other applications.

### A. INTRODUCTION

Because annotating this information is prohibitively expensive, this patent document presents systems and methods for generating and using one or more classification models that classify entities into PMEs or operating companies (OCs) based on a variety of factors or features, such as (by way of example and not limitation): litigation behavior, the patents they assert in litigation, and their presence on the Web. It will be shown herein that a classifier may be trained that uses relatively simple features extracted for a training set of less than 400 entities and that can successfully separate PMEs from operating companies with a F1 score of 85%.

Such a classifier methodology is useful for: (a) gaining a clearer picture of a vast number of patent contested proceedings that have been instituted over the last several years, and (b) immediately assessing new contested proceedings as they are filed, allowing policy makers and others to see what types of entities are engaging in proceedings without waiting months to years for human researchers to interpret the data.

It should also be noted that the ability to automatically classify entities has important policy implications because it will provide policy makers with the data they need to make decisions. Instead of only looking at a subset of cases, as other studies have, a classifier according to embodiments of the present invention can allow policy-makers and others to glean insights on years of data, and to gain insights on current proceedings as they are filed, instead of forcing policymakers and others to wait months or years for humans to interpret the data.

### B. RELATED WORK

To the best of the inventors' knowledge, there are no other approaches that automatically identify PMEs and/or analyze their behavior. However, several previous studies (see, for example, References [9], [4], [6], [10], [2], and [1]) implemented manual efforts in this direction. For example, one provision of the America Invents Act directed the Government Accountability Office (GAO) to conduct a study “on the consequences of patent infringement lawsuits brought by non-practicing entities.” (157 CONG. REC. S5441 (daily ed. Sep. 8, 2011) (statement of Sen. Patrick Leahy)). This study (see Reference [9]) was conducted by Lex Machina, which randomly sampled 100 cases per year for patent infringement lawsuits filed between 2007 and 2011 and classified the patent plaintiffs in each case. The GAO gave permission for Lex Machina to perform its own analysis of the data, and Lex Machina found that the percentage of lawsuits filed by monetizers rose from 22% of cases filed in 2007 to 40% of cases filed in 2011. Even though this study was limited by the GAO to a small subset of the thousands of cases filed in those years, it clearly demonstrated that there was a significant increase in PME activity recently.

Although others have studied monetizer litigation activity, studies have been limited because of the cost and time it takes currently to manually analyze cases. For example, it took the Lex Machina researchers hundreds of hours to analyze 500 cases. In addition, human researchers fatigue, lacking the capacity of a machine to apply the same empirical rigor to thousands of cases.

Few previous attempts have been made to build models. For example, Surdeanu et al. (Reference [13]) attempted to forecast the outcomes of patent infringement lawsuits using empirical factors derived from the litigation behavior of the entities involved, such as past win rates for the parties and counsel involved. Other researchers have attempted to predict outcomes in construction litigation using neural networks (Reference [3]) or using particle swarm optimization (Reference [5]). However, the inventors are unaware of any other work regarding automated empirical models for the identification of PMEs.

### C. FEATURES AND MODEL

In embodiments, systems and methods of the present invention classify parties, applicants, plaintiffs, or declaratory judgment defendants in a given contested proceeding rather than independent of the proceeding. It shall be noted that, in embodiments, the term “litigation” may be construed to include any contested proceeding. A contested proceeding may include, but is not limited to, a civil litigation, an International Trade Commission (ITC) proceeding, a patent office proceeding (such as, by way of illustration and not limitation, interference, derivation proceeding, ex parte reexamination, inter partes reexamination, inter partes review, protest, opposition, post-grant review proceeding, and the like), arbitration, mediation, and the like. In embodiments, reviewing the status of an entity in a given proceeding can be important because PME status may change over time or in different context, e.g., a company may start as an operating entity and later switch to a PME business model. For example, GS Cleantech Corporation was incorporated in 2005 and initially operated as a “development stage company,” which “commercializ[ed] oil extraction technologies.” By the end of Fiscal Year 2010, however, GS Cleantech had switched their focus to become “a streamlined, post-market acceptance, technology licensing company focused entirely on building value by supporting the full utilization of our now-mature technologies by as many licensed ethanol producers as possible” as stated in its 10-K filing.

For each of the entities analyzed in this work, a series of features were extracted that model, among other things, their litigation behavior, the patents they asserted, and their presence on the web. Examples of the present invention set forth herein demonstrate that PMEs may be empirically identified based on extracted features. In embodiments, the features may be extracted manually, automatically, semi-automatically, or a combination thereof. In generating a training data set, features were initially annotated by law student coders and later reviewed by a domain expert (one of the inventors). However, it shall be noted that one skilled in the art shall recognize that feature extraction may be automated.

1. Features Extracted from Litigation Data

In embodiments, an entity's litigation pattern may be an indicator of status. For example, if an entity has been sued for patent infringement, this is a strong indicator that the entity is an operating company, since an entity can only be sued for patent infringement if it makes a product. Conversely, the earlier study conducted by Jeruss et al. (Reference [9]) using data from the GAO study showed that suing over 20 defendants in a single case or filing over 20 cases concurrently is indicative of monetizer activity. The same study indicated that monetizers rarely file suit with more than one other entity, so number of plaintiffs can also serve as an indicator of entity status. Following these observations, in embodiments, the following binary features may be considered as features for a model:
The current lawsuit has 2+ or 3+ plaintiffs;
The entity in question has been previously sued in a patent case;
The entity has filed 10+, 20+, or 30+ concurrent cases with this lawsuit; and
The entity has filed 10+, 20+, or 30+ lawsuits in a time period (e.g., the same month) in the past.
The entity has filed individual lawsuits against 10+, 20+, or 30+ plaintiffs in the past.

All these features were extracted automatically from a litigation database compiled by Lex Machina, Inc. (LMI). LMI is a “spin-off” of the Stanford Intellectual Property Litigation Clearinghouse (the “IPLC”). The mission of the IPLC and its commercial successor is to support the United States with accurate empirical data on the patent litigation system. Its database is widely considered one of the most reliable sources of US intellectual property litigation data.

LMI uses automation to ensure that data is as error free as possible and free of duplicate or missing records. In embodiments, LMI's content treatment workflow includes several mark-up and linking steps implemented in Java and invoked from Python by XML-RPC calls. LMI's database contains data for patent lawsuits filed since 2000. In embodiments, LMI's crawler extracts data and documents daily from the Public Access to Court Electronic Records (PACER) system, all 94 District Court sites, the ITC's Electronic Document Information System (EDIS), and the PTO site. The crawler automatically captures docket events and downloads key case documents. It converts, if needed, the documents by optical character recognition (OCR) to searchable text and stores each one as a PDF file. In embodiments, when the crawler encounters an asserted or cited patent, it fetches information about that patent from the PTO site. In embodiments, the crawler invokes LMI's natural language processing (NLP) technology. In embodiments, the NLP processes classify cases and dockets and resolves entity names. These NLP processes include:

Named Entity Resolution (NER) Module.

In embodiments, this component matches variants of names that point to the same entity (e.g., “Microsoft” and “Microsoft, Inc.”). This step may be performed for entity names, attorney names, law firm names, and judges. A rule-based system makes deterministic changes to names to enable easier matching by removing prefixes, suffixes, or both. Some of these changes are specific to the entity type to be solved. For example, the rules for law firm names allow firm names to change as new partners are promoted or old ones leave. Judge names are matched against LMI's judge taxonomy.

Affiliate Clusters.

In embodiments, an extension of LMI's basic NER system clusters together named entities into affiliate clusters. For example, “Samsung America” and “Samsung Electro-Mechanics” are both members of the “Samsung” cluster. These clusters are used to improve search and provide recommendations regarding entities. The algorithm behind this second NER layer uses string similarity combined with litigation graph analysis. For example, two entities that have close names and appear together as defendants in the same case are clustered together. LMI's legal team has a tool that they can use to manually adjust affiliate cluster construction.

Docket Event and Case Tagging.

In embodiments, this component tags both docket events and cases with semantic tags. In embodiments, LMI uses a language called Lexpressions to write grammars for this task. LMI's previous experience found that traditional machine learning (ML) approaches do not work for this task because they fail to capture long distance dependencies between words. Lexpressions captures such dependencies with a simple and concise language. In addition, Lexpressions has a powerful syntax to handle negations. Lexpressions can be combined through conjunctions, disjunctions, and priorities, and can be applied to individual sentences or complete documents.

Information Extraction from Pleadings.

In embodiments, this component performs information extraction (IE) from pleading documents. In embodiments, this component includes the following functionalities: a) it identifies claim paragraphs in pleading documents using a ML learning model based on logistic regression; b) it extracts patent numbers from claims, using ANTLR (ANother Tool for Language Recognition) grammars (one skilled in the art shall recognize that other parser generators and rules may be employed); c) it extracts claim types (e.g., infringement or non-infringement) and their attributes (e.g., willful or contributory infringement) using a combination of Java code and ANTLR grammars. LMI currently deploys a simplified view of this data, which indicates which patents have been asserted in a case. In embodiments, a user interface case tool may be used to correct missing or incorrect extractions. In embodiments, this information extraction component may operate with other entity types (e.g., statutes, ANDA numbers, other types of patents such as plant patents, etc.).

In embodiments, LMI's data system enables users to run search queries, including automated search queries, which deliver easy access to the relevant docket entries and documents. It also generates lists that can be downloaded as PDF files or spreadsheet-ready CSV files.

Additional information regarding the LMI database, Lexpressions, and its NPL processes can be found in co-pending and commonly assigned U.S. application Ser. No. 13/745,117, entitled “Systems and Methods for Using Non-Textual Information in Analyzing Patent Matter,” which was filed on Jan. 18, 2013, and which is incorporated herein by reference in its entirety.

2. Features Generated from Raw Text

Entities often describe themselves on documentation, such as their website. Accordingly, there typically are significant textual differences between the websites of operating companies and the websites of monetizers. For example, monetizers are more likely to use words such as “inventors” “licensees,” “monetize,” “litigate,” and “patent.” Conversely, operating companies are more likely to describe sales of a product or provision of a service. Furthermore, sources unrelated to the entities, such as Internet blogs and news articles can also provide information on an entity's status. For example, on Internet blogs, monetizers are more likely to be characterized as “patent trolls,” “non-practicing entities,” or “patent assertion entities.”

In embodiments, to exploit this observation, external descriptions of entities are extracted using the following process:
In embodiments, if the entity's website is readily available, its content is used in the next steps. Otherwise, using a search engine, the top hits for a query consisting of the entity name are retrieved, excluding hits that did no more than copy a complaint from an entity's existing litigation.
In embodiments, from these documents, sentences that contained the entity name are extracted. The following shows a couple examples of external descriptions of entities, in which the first sentence corresponds to a PME and the second sentence corresponds to an OC:

“Catch Curve, Inc. is an intellectual property development and licensing company focused on communications and messaging technologies based in Atlanta, Ga.”

“LunarEYE, has developed and patented hardware which, combined with the black box data recorders designed by Salt Lake City-based Independent Witness Inc., allows operators of vehicle fleets—such as BP—to track the vehicles and respond to various situations.”
In embodiments, the bag of words from these sentences is converted into categorical features. For example, the feature “containsWord: licensing” is triggered with a weight of 2 if the word “licensing” appears twice in the corresponding texts.
In embodiments, if no such sentences were found for the given entity, a binary feature that recorded this was created. This information is useful as many PMEs do not have a Web presence.

One skilled in the art shall recognize that other features may be generated from raw text.

3. Features Created Using Natural Language Processing

In addition to the above descriptions extracted from the Web, entities commonly describe themselves in litigation documents, either in complaints or in the briefing on motions to transfer (where an entity has to explain why the case should not be moved to another venue). The statements entities make in these documents contain predictable keywords. For example, when an entity claims to sell a product or provide a service in a complaint, it is likely to do so in a single sentence in the “Facts” section of the complaint. If an entity does not shed light on its business in the complaint, it will often be forced to do so in the briefing on a motion to transfer. Accordingly, entity oppositions to motions to transfer can be scanned for key sentences and words, such as a statement that the entity sells or does not sell products or a statement that the entity's business activities consist of licensing.

In embodiments, given these observations, the following features may be extracted:
In embodiments, the relevant litigation documents (e.g., complaints and motions to transfer) were automatically extracted from Lex Machina's database using a propositional-logic classifier, such as the one discussed by Nallapati and Manning in Reference [11]. This classifier assigns 15+ semantic labels, including complaint and motion to transfer, to documents downloaded from the PACER based on the content of the corresponding docket events. It shall be noted that other sources, such as ITC and patent office proceedings may also be used.
In embodiments, from these documents and the external descriptions obtained from the Web, a series of features were extracted using simple natural language processing (NLP) heuristics: (a) an entity was marked as selling a product if the entity name appears in the same sentence with one or more product-sales related keywords, such as (by way of example and not limitation): “development,” “manufacture,” “distribution,” “markets,” “supplier,” “retail,” “product,” “importing,” “sales,” and “sells;” (b) similarly, a feature was generated which indicated that the entity was identified as a PME, if its name appears in the same sentence with any of the following keywords and phrases (by way of example and not limitation): “licensing,” “licensees,” “sells no goods or services,” “does not sell,” “does not do business,” “only licenses,” “established to license or enforce,” “patent holding company;” and finally (c) a feature was created to point that the entity was identified as an OC if its name is found in the same sentence with relevant keywords such as those listed under (a) indicating that it sells a product or similar keywords and phrases, such as: “provides,” “service,” “multinational provider,” “global provider,” to indicate that the entity provides a service.

4. Non-Textual Features

It shall be noted that there are several non-textual features that can shed light on an entity's status. Some non-textual features that may be considered are presented below:
In embodiments, if the entity's address and the address of its litigation counsel exist in the lawsuit complaint, the addresses were compared, and a feature (e.g., a Boolean feature) was created with the result. Sharing an office with a counsel's firm hints that the entity only exists to monetize patents.
In embodiments, the entity's state of incorporation was recorded in order to model geographical preferences of PMEs and OCs.
In embodiments, using the same state incorporation records, it was checked whether the entity was incorporated within a time period (e.g., the last six months) of the lawsuit filing date, which is another hint that the entity was created solely for litigation purposes.
In embodiments, USPTO assignment records were extracted to determine whether the patents asserted in the current lawsuit were assigned to the entity within a recent time period (e.g., six months) of the lawsuit filing date. This is another practice common to PMEs.
In embodiments, it was verified whether the entity has a website. Frequently, PMEs do not have a Web presence, but this is uncommon for OCs, which need the visibility to sell their products.

5. Features Generated from Existing Knowledge of PMEs

As discussed above, a database of known monetizers and of law firms known to represent PMEs was generated as part of the work done for Reference [9]. This information provided a training set of data to help develop a model. Also, in embodiments, using this information, two additional features were created:

(1) Using the USPTO patent assignment chains, a binary feature was created to indicate if the patents asserted in this case were assigned to the current entity by a known PME; and

(2) A binary feature was created to indicate if the entity's counsel is known to represent PMEs.

Turning now to FIG. 1, depicted is a method for generating a classifier using features. As shown in FIG. 1, a set of features are extracted (105). In embodiments, some or all of the features discussed above may be used. One skilled in the art shall recognize that other features may be used. In embodiments, using the set of features and a training set of data, key features may be identified (110) as part of the training processes.

In embodiments, the features may be incorporated into a logistic regression classifier with L2 regularization, and the classifier may be trained (115) using L-BFGS optimization, although it shall be noted that other methodologies may be used. The inventors used the implementation from Stanford's CoreNLP software suite. One skilled in the art shall recognize that a number of other classifiers and classifier training methodologies exists and may be successfully employed.

### D. EMPIRICAL EVALUATION

Results are presented herein to demonstrate possession of the inventive aspects presented in the current patent document and to demonstrate its improved results over prior methods. These results were performed using specific embodiments and under specific conditions; accordingly, nothing in these results sections shall be used to limit the inventions of the present patent document. Rather, the inventions of the present patent document shall embrace all alternatives, modifications, applications and variations as may fall within the spirit and scope of the disclosure.

For this study, the inventors annotated 400 plaintiffs, randomly selected from lawsuits filed in 2007, available from Lex Machina's database. From this dataset, the inventors eliminated 30 entities, which could not be classified by any of the coders into one of the two classes (PME or OC) due to insufficient evidence.

The remaining dataset of 370 plaintiffs contains 353 unique entities. Note that, although a few of the entities repeat, i.e., they appear as plaintiffs in more than one lawsuit, the data points used for classification are considerably different in each lawsuit, because most features are generated in the context of the current case and, in embodiments, the actual entity name was not used as a feature. All the results reported here are obtained through five-fold cross-validation over this dataset of 370 plaintiffs.

The cross-validation setup was chosen to maximize the data available for evaluation. A potential downside of cross-validation experiments is that there is no reserved partition for the tuning of model parameters. To avoid this problem, in embodiments, the proposed model may not be tuned, i.e., the default hyper parameters were used for the regularization of the logistic regression model, and feature selection was not performed. It is should also be noted that, in embodiments, the cross-validation setup need not apply to a production system. In a real-world scenario, PME detection may be implemented as a streaming task, i.e., where new contested proceedings arrive continuously and decisions are made using the previously seen entities and lawsuits.

1. Overall Results

Presented below is a table, Table 1, which shows the accuracy, precision, recall, and F1 scores for several model configurations.

TABLE 1

| | Accuracy | Precision | Recall | F1 |
|---|---|---|---|---|
| Baseline | 72.78 | — | — | — |
| Complete | 92.16 ± 0.26 | 87.50 ± 0.79 | 83.17 ± 0.79 | 85.28 ± 0.62 |
| NLP features | 82.70 ± 0.38 | 70.79 ± 0.95 | 62.38 ± 0.83 | 66.32^{†} ± 0.77 |
| Non-textual | 90.81 ± 0.24 | 85.26 ± 0.73 | 80.20 ± 0.75 | 82.65^{†} ± 0.60 |
| features | | | | |
| Litigation | 91.35 ± 0.30 | 88.76 ± 0.81 | 78.22 ± 0.90 | 83.16^{†} ± 0.69 |
| data | | | | |
| features | | | | |
| Raw text | 92.16 ± 0.26 | 89.13 ± 0.74 | 81.19 ± 0.96 | 84.97^{†} ± 0.67 |
| features | | | | |
| Features | 92.16 ± 0.26 | 87.50 ± 0.70 | 83.17 ± 0.79 | 85.28 ± 0.58 |
| using | | | | |
| other PMEs | | | | |

The top part of the table compares the model with the complete feature set against the baseline that always assigns the majority label (Operating Company). The bottom part of the table lists the results of an ablation experiment: each line shows the results of a model where a single feature group was removed. Beside each score, standard deviation values computed using bootstrap resampling over 20 iterations are shown. In the ablation experiment, the † symbol indicates that the corresponding F1 score is significantly smaller than the F1 score of the full model, according to a one-tailed paired t-test at 95% confidence interval on 20 samples obtained using bootstrap resampling.

As the table shows, the baseline obtains an accuracy of 72%, indicating that almost three quarters of the entities in our dataset are operating companies. This is consistent with results in previous work. The classifier obtains an accuracy of 92%, 20 percentage points larger than the baseline. More importantly, to understand the classifier's capacity to identify PMEs, precision (P), recall (R), and F1 for the PME class we measured, where:

$$P = \frac{correct PME Predictions}{total PME Predictions} , \\ R = \frac{correct PME Predictions}{total PME entities in database} , \\ and$$

$$F 1 = \frac{2 PR}{P + R}$$

As the table shows, the classifier obtains a precision of 87%, a recall of 83%, and an overall F1 score of 85%, which means that out of the predicted PMEs 87% were correct, and the classifier correctly identifies 83% of the total PMEs in the dataset. These results are quite promising, considering the relative simplicity of the features used and the relatively small size of the training dataset. As the scores indicate, this particular embodiment of the model has lower recall than precision, which indicates that this classifier tends to miss PMEs rather than over-predict them. As will be shown in the error analysis section, this happens mostly for ambiguous entities that have features of both OCs and PMEs, such as entities that recently changed their business model from 0° C. to PME.

2. Ablation Experiments

The second part of Table 1 lists the results of several ablation experiments. Each experiment measures the performance of the system when a feature group is removed. Each result is listed in a separate line in the table. For example, the “—NLP features” line shows the performance of the system without any natural language processing features. The results indicate that the removal of most feature groups has a statistically significant negative impact, which demonstrates that the corresponding features are beneficial.

As the table shows, in embodiments, the NLP feature group has the highest impact on performance: removing this group causes a drop in F1 score of over 18 points. This demonstrates that text is crucial for PME identification. Someone, be it the entity itself or an external source, unambiguously describes the entity's activity in court documents or the Web. However, to correctly model this information one needs natural language processing to extract only the relevant descriptions and to filter out the noise caused by the verbosity typical in court documents. Otherwise, in embodiments, this noise overwhelms the classifier. To demonstrate this, in a preliminary experiment, bag-of-words features from the paragraphs describing the entity in court documents were extracted. These features caused a five-point drop in the overall F1 score, which indicates that this embodiment of the classifier did not filter out the noise on its own and could benefit from the support of a more-complex NLP module.

In embodiments, the non-textual features have the second highest contribution to overall performance. Removing these features yields a drop of more than 2.5 F1 points. The fact that these features prove to be more important than features extracted from litigation data was surprising but encouraging, as they are all based on publicly-available information. The next sub-section explains which individual features in this group are the most relevant.

In embodiments, removing the features extracted from litigation data yields a significant drop of more than 2 F1 points. This result is in line with observations from previous work, which noted that PMEs have specific litigation behavior.

In embodiments, the features extracted from the raw text of external descriptions of entities are the last to have a significant impact on overall performance. This result apparently contradicts the experiment discussed above, where it was observed that modeling the raw text of entity descriptions in court documents is not beneficial. A reason for this difference is that while court documents tend to be verbose (hence they contain more information that is not useful or is harder to model), the external descriptions extracted from Web documents are concise and unequivocal and, thus, easier to model. Overall, the impact of these raw text features is small: 0.3 F1 points. It is believed that this is caused by the fact that, in this embodiment, we extracted external descriptions of entities only when such descriptions were not available in court documents. Thus, these features are triggered rarely. It shall be noted that embodiments may include models that use features obtained from more data extracted from the Web.

Finally, it is observed that removing the features generated using existing knowledge of PMEs does not affect performance. This is explained by the fact that when PMEs interact it is usually behind the scenes and this is not modeled by these features. In embodiments, more sophisticated features or models may consider entity relationships which may be extracted from corporate disclosure statements, data stores, websites, and other sites such as corporationwiki.com. Because of this, the features in this group are active for less than 5% of the datums in our entire dataset and, thus, have little say on the overall results. However, this result is considered a positive outcome: these features are not trivial to replicate because they require pre-existing knowledge of PMEs, which is not readily available.

3. Analysis of Model Weights

For a more in-depth understanding of this embodiment of the model, the ten largest weights learned for the PME and the OC classes are shown in FIGS. 2 and 3, respectively. These weights indicate what the model believes to be the most important features for each class, based on the evidence seen in training data. For a better understanding of the task, for this post-hoc analysis a separate model was trained using the whole dataset. Obviously, this model cannot be used for the prediction experiments discussed above because its performance will be artificially high, as it has seen all examples during training.

Consistent with the previous ablation experiment, the top features for the PME class involve NLP (selfDescriptionAsOperating:false and selfDescriptionAsPME:true), which, not surprisingly, indicate that PMEs describe themselves as PMEs and not OCs in court documents. A third NLP feature appears in the top 10 for the PME class (sellsProduct:false). For the OC class, two other self-explanatory NLP features appear in the top 10: sellsProduct:true and externalSourcesReferAsOperating:true. Overall, 25% of the features in the top 10 for either class are generated using NLP.

In embodiments, the top feature for the OC class requires that the entity's address not be similar to the counsel's address (the opposite is an indicator of PME status). Most of the other non-textual features appearing in the top 10 in either class store the state of incorporation. Using this information, the classifier learns geographical preferences for both PMEs and OCs. For example, the PMEs in the dataset tend to be incorporated in North Carolina, Kentucky, Oregon but also in Ontario, Canada. In general, being incorporated outside of the continental U.S. (with the exception of Ontario) is indication of OC activity (e.g., Australia, Puerto Rico and England appear in the top 10 features for OC). An interesting feature in this set is stateOfInc:N/A, the third most important feature for the PME class, which indicates that this information could not easily be found in publicly-available documents. This is another indicator that PMEs tend to minimize their web presence. Another non-textual feature, created using the asserted patents and information from the USPTO, appears in the top 10 for the OC class: patentAssignedWithinSixMonthsOfFiling:false. As its name indicates, this feature indicates that the asserted patents were not assigned to the current entity within six months of filing this lawsuit. Finally, the last non-textual feature in the top 10 is businessInAttorneyOffice:true, which, surprisingly, appears as relevant for the OC class. This feature may be a consequence of model overfitting, which happens due to the relatively small size of the dataset.

In this embodiment, only one feature created using litigation data appears in the top 10 (although many appear in the top 100 and their impact, as shown before, is significant): threeOrMorePlaintiffs:true. Interestingly, this feature is associated with the PME class, which contradicts previous work which observed that PMEs tend to file lawsuits alone. This is not true in this dataset, where several PMEs file lawsuits together with related entities, such as their parent organizations. As a simple example, “Monsanto Technology LLC”, a PME, usually files lawsuits jointly with its OC parent, “Monsanto Company.”

Lastly, one feature generated using existing knowledge of PMEs appears in the top 10 for the PME class: assignmentChainIncludesPME:true. However, as discussed before, these features were rarely active during evaluation, and thus have a minimal impact on overall performance.

Tables 2 and 3 provide longer listings of PME features and OC features, respectively, and their associated weights from the sample embodiment model, wherein higher weighting values indicate more important features.

TABLE 2
PME features and their associated weights
from the sample embodiment model.

| Feature Name | Weight |
|---|---|
| selfDescriptionAsOperating:false | 0.948312619 |
| selfDescriptionAsPME:true | 0.79792575 |
| stateOfInc:N/A | 0.719424016 |
| threeOrMorePlaintiffs:true | 0.709940737 |
| stateOfInc:Ontario,Canada | 0.668209657 |
| sellsProduct:false | 0.607627817 |
| assignmentChainIncludesPME:true | 0.549995962 |
| stateOfInc:NorthCarolina | 0.490622362 |
| stateOfInc:Kentucky | 0.470459133 |
| stateOfInc:Oregon | 0.433407959 |
| stateOfInc:Illinois | 0.427797919 |
| selfDescriptionAsSubsidiary:false | 0.426557017 |
| entitySuedAfter2000:false | 0.414779904 |
| stateOfInc:Delaware | 0.397375494 |
| entitySuedAfter2000:true | 0.393977499 |
| stateOfInc:Texas | 0.361147394 |
| stateOfInc:Massachusetts | 0.338966051 |
| stateOfInc:Nevada | 0.335637083 |
| twoOrMorePlaintiffs:false | 0.331532494 |
| lawFirmRepresentsPME:true | 0.317551186 |
| prevover20:true | 0.309094306 |
| stateOfInc:Japan | 0.292415142 |
| stateOfInc:Florida | 0.276883508 |
| stateOfInc:Delware | 0.268607783 |
| stateOfInc:Israel | 0.264464552 |
| stateOfInc:RepublicofKorea | 0.259506646 |
| stateOfInc:NJ | 0.189158091 |
| stateOfInc:NewYork | 0.18687833 |
| stateOfInc:n/a | 0.177387606 |
| externalSourcesReferAsPME:true | 0.142717571 |
| stateOfInc:Connecticut | 0.105175625 |
| stateOfInc:Minnesota | 0.094428215 |
| stateOfInc:Australia | 0.081816304 |
| stateOfInc:Oklahoma | 0.071342033 |
| hasWebsite:false | 0.065533151 |
| twoOrMorePlaintiffs:true | 0.065296633 |
| stateOfInc:Indiana | 0.051490496 |
| entityFormedWithinSixMonthsOfFiling:false | 0.04404907 |
| externalDesc:software | 0.042724624 |
| externalDesc:Creek | 0.040928383 |
| externalDesc:Bear | 0.040928383 |
| externalDesc:Technologies | 0.040928383 |
| externalDesc:Orange | 0.040928383 |
| externalDesc:firm | 0.040928383 |
| externalDesc:protection | 0.040928383 |
| externalDesc:Property | 0.040928383 |
| externalDesc:Intellectual | 0.040928383 |
| externalDesc:breach-of-contract | 0.040928383 |
| externalDesc:verdict | 0.040928383 |
| externalDesc:Chapter | 0.040928383 |

TABLE 3
OC features and their associated weights
from the sample embodiment model.

| Feature Name | Weight |
|---|---|
| businessInAttorneyOffice:false | 0.76425641 |
| sellsProduct:true | 0.69608072 |
| stateOfInc:PuertoRico | 0.59126979 |
| selfDescriptionAsPME:false | 0.5839468 |
| stateOfInc:Australia | 0.51189071 |
| businessInAttorneyOffice:true | 0.47458213 |
| stateOfInc:Washington | 0.47024223 |
| externalSourcesReferAsOperating:true | 0.44305588 |
| patentAssignedWithinSixMonthsOfFiling:false | 0.43420372 |
| stateOfInc:Stonehouse,Gloucestershire,England | 0.43263273 |
| stateOfInc:California | 0.40007762 |
| prevover30:true | 0.3221548 |
| lawFirmRepresentsPME:false | 0.31932559 |
| threeOrMorePlaintiffs:false | 0.31548298 |
| selfDescriptionAsOperating:true | 0.30588087 |
| stateOfInc:Utah | 0.28613099 |
| stateOfInc:Nocomplaint | 0.26989789 |
| patentAssignedWithinSixMonthsOfFiling:true | 0.2680956 |
| stateOfInc:CA | 0.2607379 |
| stateOfInc:Osaka,Japan | 0.25742832 |
| stateOfInc:Barbados | 0.23470415 |
| selfDescriptionAsSubsidiary:true | 0.22803078 |
| externalSourcesReferAsPME:false | 0.22224952 |
| stateOfInc:Taiwan | 0.21389691 |
| hasWebsite:true | 0.20172419 |
| stateOfInc:Michigan | 0.18120762 |
| stateOfInc:Pennsylvania | 0.17879432 |
| stateOfInc:Ohio | 0.16073751 |
| externalDesc:hardware | 0.15849654 |
| externalDesc:patented | 0.15661894 |
| stateOfInc:MN | 0.1492376 |
| entityFormedWithinSixMonthsOfFiling:true | 0.14569772 |
| externalDesc:Lunareye | 0.13575897 |
| stateOfInc:Delaware(attimeofcomplaint) | 0.13117102 |
| stateOfInc:delaware | 0.12925969 |
| externalDesc:develop | 0.12743173 |
| stateOfInc:NY | 0.119837 |
| stateOfInc:MI | 0.11935071 |
| externalDesc:INC | 0.09967571 |
| stateOfInc:Norway | 0.09874944 |
| stateOfInc:Colorado | 0.09791243 |
| externalDesc:SERV | 0.09605552 |
| externalDesc:INCORP | 0.09605552 |
| stateOfInc:Canada | 0.09329887 |
| stateOfInc:NewJersey | 0.08266978 |
| prevover10:true | 0.08219927 |
| stateOfInc:UK | 0.08206875 |
| stateOfInc:NJ,Delaware | 0.0819454 |
| assignmentChainIncludesPME:false | 0.07477944 |
| externalDesc:Climate | 0.06862555 |

One skilled in the art shall recognize that different models, different training sets, or both would result in different features and weights. The previous listings are provided by way of example and not limitation.

4. Error Analysis

Presented herein is an error analysis of the example model. As shown in Table 1, the example model has lower recall than precision, which indicates that most errors come from PMEs misclassified as OCs. Inspecting this data, it was found that a considerable percentage of these false negatives (50%) were errors for the training data set. For example, “Monsanto Company,” an operating company, was confused with “Monsanto Technology LLC,” its PME subsidiary, and assigned it the incorrect PME label. Embodiments of the present invention correctly classified “Monsanto Company” as an OC but, because of the incorrect gold label, this is counted as a mistake during scoring.

The remaining errors are caused by entities that are hard to classify because they have properties of both OCs and PMEs, e.g., research-oriented university divisions with a strong focus on patent monetization (e.g., “Wake Forest Health Sciences”) and companies that changed their business model from 0° C. to PME. For example, Bear Creek Technologies (DE) was founded in 1993 and incorporated in 1997 and a crawl of the Bear Creek website from 2005 (available via the Internet Wayback Machine) describes Bear Creek as “an information technology company specializing in the development of software solutions, automated software products, and technological services,” and notes “Bear Creek is moving to create new products to meet the demands of existing and emerging communications markets: PCS, cellular, long distance, cable, and local exchange carriers (LECs) in the U.S. and internationally.” Although initially Bear Creek had minimal litigation activity, recently they filed 17 lawsuits, resulting in a multi-district consolidated action with over 20 defendants. In an opposition to a motion to transfer filed in Bear Creek Technologies, Inc. v RCN Corporation et al. (E.D. Va. 2011), Bear Creek characterizes all of its VOIP development and sales activity as having happened in the past. And although Bear Creek's website still exists, the section describing Bear Creek's corporate operations has been removed, as have the sections about news and hiring. Similarly, while Bear Creek retains a product page, this page does not appear to have been changed since the 2005 website crawl. These facts suggest that while Bear Creek was formerly a clear example of an operating company, it is now shifting its focus to patent monetization.

In situations such as the ones described, the corresponding datums have many features that are representative of OCs. For example, 85% of the false negative examples have at least one NLP feature that is strongly correlated with the OC class (e.g., verifiableDescriptionAsOperating:true), 64% of them have at least one non-textual feature typically associated with OCs (e.g., hasWebsite:true) and, lastly, 35% of these examples have at least one litigation-based feature indicative of OC (e.g., entitySuedAfter 2000:true). These features end up imposing the incorrect label in all these examples.

### E. CONCLUSIONS

This is the first work of which the inventors are aware that provides empirical modeling for the identification of patent monetization entities. Using cross-validation over a corpus of 370 lawsuit plaintiffs annotated as either operating companies or patent monetization entities, the model extracted PMEs with a F1 score of 85%. These results are very encouraging, especially considering that, in embodiments, the relevant features are relatively simple: we modeled the entity's litigation behavior, how entities describe themselves or are described by others in court documents and the Web, their asserted patents, and their presence on the Web. All these features were created using either data from Lex Machina's database of patent infringement lawsuits or information publicly available on the Web.

Importantly, this work makes a strong case for the utility of natural language processing in the legal domain. It has been shown that features that model higher-level semantic information (e.g., does this entity describe itself as an operating company?) and are extracted using simple NLP heuristics (e.g., matching specific keywords and phrases in the same sentence with the entity name) perform significantly better than features created by traditional bag-of-word approaches.

All in all, this work will help shed light on PME behavior in the tens of thousands of patent litigation lawsuits filed to date and also on new lawsuits as they are filed. Due to the high volumes of cases that exist or are filed, without the inventive aspects of the present invention, this analysis could not be performed, or at least could not be performed in any timely or cost-effective manner. Furthermore, as more data is added, the models can increase in both precision and recall accuracy.

It shall be noted that aspects of the present invention may be used to develop one or more models that provide more or different classifications than just PME and OC. For example, one or more models may be generated that include the following classification (by way of example and not limitation):
Operating Company
Patent Monetization Entity
Suspected Operating Company: This category may be used when evidence existed that the entity fits into the operating company category, but that evidence was not verifiable. For example, an entity described by a publication like Bloomberg BusinessWeek as selling a product would be categorized as a suspected operating company.
Suspected Patent Monetization Entity: This category may be used when there was evidence to assign an entity to the patent monetization category, but that evidence was not verifiable. For example, an entity with no known operating activities and that a patent law blog describes as a “patent troll,” would be categorized as a suspected patent monetization entity.
Linked to Operating Company: This category may be used for entities known to be related to operating companies (e.g., subsidiaries of major corporations), but for which we could not determine a specific role within the corporation.
Linked to Patent Monetization Entities: This category may be used for entities know to be related to patent monetization entities.
Individual or Trust: This category may comprise individuals or entities organized as a trust. Based on the results from the training sample, individuals and trusts appear to function more like monetizers than operating companies. Many of the individuals in the test dataset appeared to be inventors who had tried to operate companies and, when this failed, switched to litigation as a way of monetizing their patents.
University: This category may be used for universities because universities appear fundamentally different from either operating companies or monetization entities.
Other: If an entity did not fit into any of the above categories, it may be classified as “Other.” These may include entities with mixed patent monetization and operating company activities (e.g., operating two subsidiaries, one that focuses on selling a product and another that focuses exclusively on monetizing patents other than those related to the product).
Insufficient Evidence: If there was absolutely no information about an entity, it may be classified as “insufficient evidence.”

One skilled in the art shall recognize that a number of different categories and classes may be formed and assigned to entities based upon modeling.

### F. COMPUTING SYSTEM IMPLEMENTATIONS

FIG. 4 depicts a block diagram of a model trainer for developing a patent monetizing classifier model according to embodiments of the present invention. As shown in FIG. 4, the model trainer 405 comprises one or more feature extractors 410 and a model trainer 415. In embodiments, the feature extractor 410 receives or can acquire input data 450, such as websites, the LMI database(s), publicly available documents, etc. In embodiments, the feature extractor 410 receives or accesses the data to extract features such as the ones previously discussed. For example, in embodiments, the feature extractor may:

(1) automatically extract the number of plaintiffs, number of lawsuits filed, and whether the entity has ever been sued for patent infringement from a patent litigation database;

(2) automatically extract entity descriptions from external sources available on the Internet by:
a. either accessing an entity website or using a search engine to retrieve top hits for a query consisting of the entity name, excluding hits that did no more than copy a complaint from an entity's existing litigation;
b. extracting sentences that contain an entity's name via computerized natural-language processing technology;
c. converting words from the extracted sentences into categorical features such as “licensing” and “sales” and automatically assigning weights to those categorical features based on how many times they appear in the corresponding texts; and/or
d. where no sentences are found for the given entity, creating a binary feature that automatically records this fact;

(3) automatically extract entity descriptions from litigation documents found in a patent litigation database using a propositional logic-classifier to extract relevant litigation documents;

(4) using the litigation documents and the documents extracted from the Internet, apply natural-language processing heuristics via a computer system as follows:
a. mark that the entity sells a product if the entity name appears with one or more of the following keywords: “development,” “manufacture,” “distribution,” “markets,” “supplier,” “retail,” “product,” “importing,” “sales,” “sells,” and the like in the same sentence;
b. indicate that the entity was identified as a patent monetization entity if the name appears in the same sentence as any of the following keywords or phrases: “licensing,” “licensees,” “sells no goods or services,” “does not sell,” “does not do business,” “only licenses,” “established to license or enforce,” or “patent holding company”; and/or
c. indicate that an entity is identified as an operating company if its name is found in the same sentence with relevant keywords as those listed under (a) (above) or if it sells products or similar phrases such as “provides,” “service,” “multinational provider,” or “global provider,” to indicate that the entity provides a service;

(5) generate non-textual features for the classification model, including:
a. creating a Boolean feature indicating whether an entity's address indicated in a patent infringement complaint and the address of its litigation counsel are the same;
b. recording the entity's state of incorporation and modeling geographical preferences of PMEs and operating companies;
c. using state incorporation records to check whether an entity was incorporated within six months of the lawsuit filing date;
d. using USPTO assignment records to check whether the patent asserted in the patent infringement lawsuit at issue was assigned to the filer within 6 months of the lawsuit filing date; and/or
e. Verifying whether the entity has a website; and/or

(6) incorporate features generated from existing knowledge of PMEs by:
a. Creating a binary feature indicating whether the patents asserted in the case were assigned to the plaintiff by a known PME; and/or
b. Creating a binary feature indicating whether the entity's counsel is known to represent PMEs.

The extracted features are supplied to the model trainer module 415. Using the inputted features and given a training set of entities with ground truth PME/OC labels, a model can be trained. In embodiments, the model may be based upon logistic regression; however, one skilled in the art of modeling shall recognize that a number of models and combinations of models may be used for classification. The model trainer then outputs a trained model 455 that may be used to predict a label or classification (e.g., PME or OC) for an entity.

FIG. 5 depicts a block diagram of an entity model classifier 505 that uses the trained model 455 to classify an entity according to embodiments of the present invention. As shown in FIG. 5, the classifier 505 comprises a features extractor(s) 510 and a classifier 515. In embodiments, the feature extractor 510 may be the same feature extractor used in the trainer 405. In embodiments, the feature extractor 510 receives or accesses data to extract features—as previously discussed above. This feature information is supplied to the classifier 515 that uses the trained model 455 and the extracted features to predict a label for the input entity. Based upon the model values, a label may be assigned to the entity, and is output 555 to a user.

In embodiments, the entity model trainer 405, the entity model classifier 505, or both may be implemented using one or more computer systems. In embodiments, one or more computing system may be configured to perform one or more of the methods, functions, and/or operations presented herein. Systems that implement at least one or more of the methods, functions, and/or operations described herein may comprise an application or applications operating on at least one computing system. The computing system may comprise one or more computers and one or more databases. The computer system may be a single system, a distributed system, a cloud-based computer system, or a combination thereof.

It shall be noted that the present invention may be implemented in any instruction-execution/computing device or system capable of processing data, including, without limitation phones, laptop computers, desktop computers, and servers. The present invention may also be implemented into other computing devices and systems. Furthermore, aspects of the present invention may be implemented in a wide variety of ways including software (including firmware), hardware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

FIG. 6 depicts a functional block diagram of an embodiment of an instruction-execution/computing device 600 that may implement or embody embodiments of the present invention. In embodiment, the computing device or devices may operate in different environments or configurations, including without limitation a client and a server, software-as-a-service, a standalone device, distributed computing, etc.

As illustrated in FIG. 6, a processor 602 executes software instructions and interacts with other system components. In an embodiment, processor 602 may be a general purpose processor such as (by way of example and not limitation) an AMD processor, an INTEL processor, a SUN MICROSYSTEMS processor, or a POWERPC compatible-CPU, or the processor may be an application specific processor or processors. The processor or computing device may also include a graphics processor and/or a floating point coprocessor for mathematical computations. In embodiments, a storage device 604, coupled to processor 602, provides long-term storage of data and software programs. Storage device 604 may be a hard disk drive and/or another device capable of storing data, such as a magnetic or optical media (e.g., diskettes, tapes, compact disk, DVD, and the like) drive or a solid-state memory device. Storage device 604 may hold programs, instructions, and/or data for use with processor 602. In an embodiment, programs or instructions stored on or loaded from storage device 604 may be loaded into memory 606 and executed by processor 602. In an embodiment, storage device 604 holds programs or instructions for implementing an operating system on processor 602. In one embodiment, possible operating systems include, but are not limited to, UNIX, AIX, LINUX, Microsoft Windows, and the Apple MAC OS. In embodiments, the operating system executes on, and controls the operation of, the computing system 600.

An addressable memory 606, coupled to processor 602, may be used to store data and software instructions to be executed by processor 602. Memory 606 may be, for example, firmware, read only memory (ROM), flash memory, non-volatile random access memory (NVRAM), random access memory (RAM), or any combination thereof. In one embodiment, memory 606 stores a number of software objects, otherwise known as services, utilities, components, or modules. One skilled in the art will also recognize that storage 604 and memory 606 may be the same items and function in both capacities. In an embodiment, one or more of the methods, functions, or operations discussed herein may be implemented as modules stored in memory 604, 606 and executed by processor 602.

In an embodiment, computing system 600 provides the ability to communicate with other devices, other networks, or both. Computing system 600 may include one or more network interfaces or adapters 612, 614 to communicatively couple computing system 600 to other networks and devices. For example, computing system 600 may include a network interface 612, a communications port 614, or both, each of which are communicatively coupled to processor 602, and which may be used to couple computing system 600 to other computer systems, networks, and devices.

In an embodiment, computing system 600 may include one or more output devices 608, coupled to processor 602, to facilitate displaying graphics and text. Output devices 608 may include, but are not limited to, a display, LCD screen, CRT monitor, printer, touch screen, or other device for displaying information. Computing system 600 may also include a graphics adapter (not shown) to assist in displaying information or images on output device 608.

One or more input devices 610, coupled to processor 602, may be used to facilitate user input. Input device 610 may include, but are not limited to, a pointing device, such as a mouse, trackball, or touchpad, and may also include a keyboard or keypad to input data or instructions into computing system 600.

In an embodiment, computing system 600 may receive input, whether through communications port 614, network interface 612, stored data in memory 604/606, or through an input device 610, from (by way of example and not limitation) a scanner, copier, facsimile machine, server, computer, mobile computing device (such as, by way of example and not limitation a phone or tablet), or other computing device.

In embodiments, computing system 600 may include one or more databases, some of which may store data used and/or generated by programs or applications. In embodiments, one or more databases may be located on one or more storage devices 604 resident within a computing system 600. In alternate embodiments, one or more databases may be remote (i.e., not local to the computing system 600) and share a network 616 connection with the computing system 600 via its network interface 614. In various embodiments, a database may be a database that is adapted to store, update, and retrieve data in response to commands.

In embodiments, all major system components may connect to a bus, which may represent more than one physical bus. However, various system components may or may not be in physical proximity to one another or connected to the same bus. In addition, programs that implement various aspects of this invention may be accessed from a remote location over one or more networks or may be conveyed through any of a variety of machine-readable medium.

One skilled in the art will recognize no computing system or programming language is critical to the practice of the present invention. One skilled in the art will also recognize that a number of the elements described above may be physically and/or functionally separated into sub-modules or combined together.

It shall be noted that embodiments of the present invention may further relate to computer products with a tangible (non-volatile) computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

### G. REFERENCES

The following references are referred to in the above text. Each of these documents is incorporated by reference herein in its entirety.
[1] J. R. Allison, M. A. Lemley, and J. Walker. Patent Quality and Settlement Among Repeat Patent Litigants. Georgetown Law Journal, 99(677), 2010.
[2] J. R. Allison, E. H. Tiller, and S. Zyontz. Patent Litigation and the Internet. Stanford Technology and Law Review, 1, 2012.
[3] D. Arditi, F. Oksay, and O. Tokdemir. Predicting the Outcome of Construction Litigation Using Neural Networks. Computer-Aided Civil and Structural Engineering, 13, 1998.
[4] J. E. Bessen and M. J. Meurer. The Direct Costs from NPE Disputes. Boston Univ. School of Law, Working Paper No. 12-34, available at http://papers.ssrn.com/sol3/papers.cfm?abstract_id=2091210, 2012.
[5] K. Chau. Prediction of construction litigation outcome using particle swarm optimization. In Proceedings of the International Conference on Industrial and Engineering Applications of Artificial Intelligence and Expert Systems, 2005.
[6] C. V. Chien. From Arms Race to Marketplace: The Complex Patent Ecosystem and Its Implications for the Patent System. Hastings Law Journal, 62(297), 2010-2011.
[7] C. A. Cotropia. The Individual Inventor Motif in the Age of the Patent Troll. Yale Journal of Law and Technology, 12(52), 2009-2010.
[8] T. Ewing and R. Feldman. The Giants Among Us. Stanford Technology and Law Review, 1, 2012.
[9] S. Jeruss, R. Feldman, and J. Walker. The America Invents Act 500: Effects of Patent Monetization Entities on US Litigation. Duke Law and Technology Review, 11(357), 2012.
[10] B. J. Love. An Empirical Study of Patent Litigation Timing: Could A Patent Term Reduction Decimate Trolls Without Harming Innovators?. Working paper, available at http://digitalcommons.law.scu.edu/cgi/viewcontent.cgi?article=1543&context=facpubs, 2012.
[11] R. Nallapati and C. D. Manning. Legal docket classification: Where machine learning stumbles. In Proceedings of the Conference on Empirical Methods for Natural Language Processing (EMNLP), 2008.
[12] R. A. Posner. Patent Trolls Be Gone. Slate Magazine, available at http://www.slate.com/articles/news_and_politics/view_from_chicago/2012/10/patent_protection_how_to_fix_it.html, October 2012.
[13] M. Surdeanu, R. Nallapati, G. Gregory, J. Walker, and C. D. Manning. Risk analysis for intellectual property litigation. In Proceedings of the Thirteenth International Conference on Artificial Intelligence and Law (ICAIL), 2011.
[14] C. T. Vrountas, R. S. Loftus, and C. P. Palmer. Patent Trolls Who, What, Where & How to Defend Against Them. New Hampshire Business Journal, 52, 2011.
[15] B. T. Yeh. An Overview of the “Patent Trolls” Debate. Congressional Research Service, available at http://www.fas.org/sgp/crs/misc/R42668.pdf, 2012.

What is claimed is:

1. A computer-implemented method for training a classifier system for detecting a status label of an entity who is a party to a contested proceeding, the method comprising:
obtaining a set of data comprising entities, each entity being associated with one or more features related to the entity and a status label indicating a status of the entity, the status labels comprising an operating company label and a patent monetizing entity label; and
using at least some of the one or more features of the entities and the status labels to train a classifier for predicting the status label of an entity in a contested proceeding.

2. The computer-implemented method of claim 1 wherein the one or more features are obtained by automatically extracting features related to entities from one or more sources comprising contested proceedings data, text data, non-textual data, and pre-existing knowledge about entities' status.

3. The computer-implemented method of claim 2 wherein the step of automatically extracting features related to entities from contested proceedings data comprises extracting data to identify one or more of the following features comprising:
whether a current contested proceeding in which the entity is a party has a plurality of plaintiffs;
whether the entity has previously been a defendant in a patent contested proceeding;
whether the entity has filed more than a threshold number of concurrent contested proceedings that are related to a particular contested proceeding; and
whether the entity has filed more than a threshold number of patent-related contested proceedings within a set time period.

4. The computer-implemented method of claim 2 wherein the step of automatically extracting features related to entities from text data comprises:
using natural language processing to identify whether an entity has described itself in at least some of the text from the text data using keywords associated with an operating company or using keyword associated with a patent monetizing entity.

5. The computer-implemented method of claim 2 wherein the step of automatically extracting features related to entities from non-textual data comprises extracting data to identify one or more of the following features comprising:
generating a feature indicating whether an entity's address and an address of the entity's counsel are the same;
recording an entity's state of incorporation;
generating a feature indicating whether an entity was incorporated within a set time period of the contested proceeding's filing date;
generating a feature indicating whether a patent application or patent that is the subject of a litigation or International Trade Commission (ITC) contested proceeding was assigned to an entity within a time period of a filing date of the litigation or ITC contested proceeding; and
generating a feature that indicates whether an entity has a website.

6. The computer-implemented method of claim 2 wherein the step of automatically extracting features related to entities from pre-existing knowledge about the status of entities data comprises:
checking an entity against one or more databases that record a status label for each entity from a set of entities.

7. A computer-implemented method for detecting a status of an entity who is a party to a patent-related contested proceeding, the method comprising:
extracting a set of features associated with the entity;
applying a pre-trained classifier to at least some of the extracted features associated with the entity to obtain a classifier response value;
based upon the classifier response value, classifying the entity's status in the patent-related contested proceeding into one of at least two categories comprising: operating company and patent monetizing entity.

8. The computer-implemented method of claim 7 wherein the set of features comprises one or more textual features, one or more non-textual features, or both.

9. The computer-implemented method of claim 7 further comprising extracting data related to one or more patent-related contested proceedings to identify one or more features comprising:
whether a current patent-related contested proceeding in which the entity is a party has a plurality of plaintiffs;
whether the entity has previously been a defendant in a patent-related contested proceeding;
whether the entity has filed more than a threshold number of patent-related contested proceedings that are concurrent with and related to the patent-related contested proceeding; and
whether the entity has filed more than a threshold number of patent-related contested proceedings within a set time period.

10. The computer-implemented method of claim 7 wherein the set of features comprises:
extracting one or more descriptions about the entity from one or more external sources.

11. The computer-implemented method of claim 10 wherein the step of extracting one or more descriptions about the entity from one or more external sources comprises:
extracting data to identify one or more descriptors indicative of status of the entity from one or more of the following sources comprising:
a website of the entity; and
search results obtained from one or more queries comprising an identify of the entity.

12. The computer-implemented method of claim 11 wherein the step of extracting data to identify one or more descriptors indicative of status of the entity comprises:
extracting one or more sets of words that contain the entity's name;
converting keywords from the extracted one or more sets of words into categorical features; and
assigning weights to each of the categorical features based on how many times it appears in the extracted one or more sets of words.

13. The computer-implemented method of claim 7 wherein the set of features comprises:
responsive to not identifying an external site that contains one or more sets of words that includes an identify of the entity, generating a feature that indicates that the entity has no presence on external sites.

14. The computer-implemented method of claim 7 wherein the set of features comprises:
extracting entity descriptions from one or more documents from one or more contested proceedings using a propositional logic-classifier to extract relevant documents.

15. The computer-implemented method of claim 10 wherein the step of extracting one or more descriptions about the entity from one or more external sources further comprises:
applying natural language processing heuristics to one or more contested proceedings documents, one or more documents extracted from one or more external sites, or both, according to one or more of the following heuristics comprising:
[a] indicating that the entity sells a product if the entity's name appears in a sentence with one or more of keywords comprising: “development,” “manufacture,” “distribution,” “markets,” “supplier,” “retail,” “product,” “importing,” “sales,” and “sells”;
[b] indicating that the entity was identified as a patent-monetization entity if the entity's name appears in a sentence with keywords or phrases comprising: “licensing,” “licensees,” “sells no goods or services,” “does not sell,” “does not do business,” “only licenses,” “established to license or enforce,” or “patent holding company”; and
[c] indicating that the entity is identified as an operating company if the entity's name is found in a sentence with one or more keywords identified in [a] (above) or if one or more keywords indicate that the entity sells a product or provides a service.

16. The computer-implemented method of claim 8 wherein the one or more non-textual features are obtained by performing one or more of the steps comprising:
generating a feature indicating whether the entity's address and an address of the entity's counsel are the same;
recording the entity's state of incorporation and modeling geographical preferences of patent monetizing entities and operating companies;
generating a feature indicating whether the entity was incorporated within a set time period of a filing date of the patent-related contested proceeding;
generating a feature indicating whether a patent application or patent that is the subject of a patent-related contested proceeding was assigned to the entity within a time period of the filing date of the patent-related contested proceeding; and
generating a feature that indicates whether the entity has a website.

17. The computer-implemented method of claim 7 wherein the set of features comprises one or more features generated from existing knowledge of patent monetizing entities by performing one or more of the steps comprising:
generating a feature indicating whether a patent or patent application at issue in a contested proceeding asserted in the case were assigned to the plaintiff by a known patent monetizing entity; and
generating a feature indicating whether the entity's counsel is known to represent patent monetizing entities.

18. A system for detecting a status of an entity, the system comprising:
one or more processors; and
a non-transitory computer-readable medium or media comprising one or more sequences of instructions which, when executed by the one or more processors, causes steps to be performed comprising:
extracting a set of features related to an entity that is party to a patent-related contested proceeding;
inputting the set of features into a model that uses at least some of the features to predict a business model practice identifier of the entity that is party to the patent-related contested proceeding; and
assigning a business practice identifier of the entity based upon an output of the model.

19. The system of claim 18 wherein the set of features are obtained by automatically extracting one or more text features and one or more non-textual data features.

20. The system of claim 19 wherein the non-transitory computer-readable medium or media comprising one or more sequences of instructions which, when executed by the one or more processors, causes steps to be performed comprising:
automatically extracting litigation-related features related to the entity;
automatically extracting one or more descriptions of the entity; and
generating one or more non-textual features related to the entity.
